(19) United States
(12) Patent Application Publication
(10) Pub. No.: US 2009/0113454 A1
(43) Pub. Date: Apr. 30, 2009

(54) SYSTEM AND METHOD OF TESTING BRIDGE SAS CHANNELS

(75) Inventors: Tian-Chao ZHANG, Tianjin (CN); Xiao JIANG, Tianjin (CN); Jhih-Ren JIN, Taipei (TW); Jeff SONG, Taipei (TW); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 11/926,211

(22) Filed: Oct. 29, 2007

(51) Int. Cl. G06F 3/00

(52) U.S. Cl. 719/321

(57) ABSTRACT

A system and a method of testing bridge SAS channels includes a control terminal, a hot-plug bridge interface, a first adaptor, an SAS back plate, and a second adaptor. The control terminal selects an SAS interface as a transmission path for sending a test signal. The hot-plug bridge interface receives and converts the test signal sent from the control terminal. The hot-plug bridge interface has a hot-plug function. The first adaptor is connected to the hot-plug bridge interface and the SAS back plate. The second adaptor is connected between the SAS back plate and a terminal unit. The control terminal sends the test signal and detects a signal under test sent back from the terminal unit, and compares whether they are consistent with each other or not. In this way, the control terminal determines whether the SAS interfaces in the SAS back plate run normally or not.

### BACKGROUND OF THE INVENTION

1. Field of the Invention

The present invention relates to a system and a method of testing bridge SAS channels. More particularly, the present invention relates to a system and a method of testing bridging a hot-plug terminal unit to the SAS channels.

2. Related Art

Serial attached SCSI (SAS) interface is a new generation of the small computer small interface (SCSI interface). The SAS is a newly-developed interface following the parallel SCSI interface. Therefore, the SAS interfaces can offer multicast interfacing function and the data can be bi-directionally transmitted at a rate of 6 Gb/s. Additionally, through the design of reducing the connection wires, the SAS interfaces have the advantage of reducing the inner space of the system, and the SAS interfaces are also backward compatible, for example, SATA (Serial ATA) hard disks.

The SAS channel utilizes low voltage difference signals (LVDS) for data transmission, and each pair of low voltage difference lines can adopt a data transmission speed of 1.5 Gbps and 3.0 Gbps according to the criterion. Compared with other interfaces, LVDS has the following advantages: (1) the LVDS is applicable for a condition with a low voltage current supply; (2) the signal generated from the LVDS has a low noise; (3) the LVDS has a high noise-tolerance property; (4) a strong signal transmission capacity; and (5) it can be easily integrated into a system-on-chip. The transmission voltage (TX) and the receiving voltage (RX) adopted by the SAS channels are respectively 800-1600 mV and 275-1600 mV. A physical connector interface of each SAS can provide four physical links at most, that is to say, each physical link is an SAS hard disk. Each physical link includes two pairs of difference lines (Tx± and Rx±, i.e., four transmission cables). Referring to FIG. 1, it is a schematic view of physical links provided by an SAS physical connector interface.

Each column in FIG. 1 indicates a different physical link, and each row indicates a different Tx and Rx set. For example, when the first physical link (referring to the scope defined by the dotted lines) is connected to an SAS physical connector interface, the first physical link utilizes Rx 0+, Rx 0−, Tx 0+, and Tx 0− of the SAS physical connector interface. If the SAS physical connector interface is connected both the first physical link and the second physical link, the first physical link is as described above, and the second physical link utilizes Rx 1+, Rx 1−, Tx 1+, and Tx 1−. It is operated in such a similar way, if there is any other physical link connected to the SAS physical connector interface.

Referring to FIG. 2, it is a schematic view of a system of testing SAS channels in the conventional art. A convention method of testing SAS channels includes the following steps. Firstly, SAS hard disks 230 are connected to a control terminal 210. Next, a detecting program in the control terminal 210 performs an accessing operation on the SAS hard disks 230. Then, it is detected whether the test signals passed through a channel corresponding to SAS interfaces 221 are intact or not through reading from and writing to the SAS hard disks 230. Referring to FIG. 3, it is a flow chart of a detection of SAS channels in the conventional art. Firstly, SAS hard disks for testing are installed on the SAS back plate (Step S310). Next, a testing program of the system is enabled (Step S320). Then, an accessing operation is performed to the SAS hard disks through the testing program (Step S330). Finally, the control terminal receives a report on the accessing test of the SAS hard disks (Step S340).

However, as the SAS back plate 220 has as much as 8-16 SAS interfaces 221, it costs a lot of time to install an equivalent number of SAS hard disks 230. Furthermore, each time when one SAS hard disk 230 is installed, the control terminal 210 has to be restarted, and thus the whole testing time is prolonged.

### SUMMARY OF THE INVENTION

In view of the above problems, the present invention is mainly directed to a system of testing bridge SAS channels, which is applicable to detect whether SAS interfaces of an SAS back plate run normally or not. The testing system bridges a plurality of terminal units to the SAS back plate, so as to detect whether the SAS channels selected by the SAS back plate run normally or not.

To achieve the above objective, the testing system of the present invention includes: a control terminal, a hot-plug bridge interface, a first adaptor, a second adaptor, and a terminal unit.

The control terminal sends a test signal and detects a signal under test sent back from the terminal unit, and selects one of the SAS interfaces as a transmission path for sending the test signal. The hot-plug bridge interface is electrically connected to the control terminal, and receives and converts the test signal sent from the control terminal. The first adaptor is electrically connected to the hot-plug bridge interface and the SAS back plate respectively, and converts a low voltage difference signal of the hot-plug bridge interface to the SAS channels. The second adaptor is electrically connected to the SAS back plate and the terminal unit respectively, and converts a low voltage differential signal of the SAS channels to the hot-plug bridge interface and accesses the terminal unit.

In another aspect of the present invention, the present invention provides a method of testing bridge SAS channels, applicable for bridging and accessing a plurality of terminal units, so as to detect whether the SAS channels run normally or not. The testing method includes the following steps: firstly, providing a first adaptor and a second adaptor to connect the SAS back plate between the first adaptor and the second adaptor respectively; next, connecting the second adaptor to the terminal unit; then, providing a hot-plug bridge interface connected to the control terminal and the first adaptor respectively; then, sending a test signal to the terminal unit from the control terminal; afterwards, sending the received signal under test back to the control terminal by the terminal unit; and finally, comparing whether the test signal and the sent back signal under test are consistent with each other by the control terminal. Additionally, the present invention further utilizes a universal serial bus (USB) or an IEEE 1394 as a hot-plug bridge interface to bridge the terminal unit of the hot-plug interface. After completing the test, the SAS back plate can be directly removed without shutting down the system.

In the present invention, the SAS back plate is used for bridging the terminal units. When it is detected whether the test signal passing through the SAS channels of the SAS back plate is intact, the SAS back plate can be replaced by a new one, without shutting down the power and rebooting the system, and thus reducing the whole time spent on testing the SAS channels.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of physical links provided by an SAS physical connector interface.

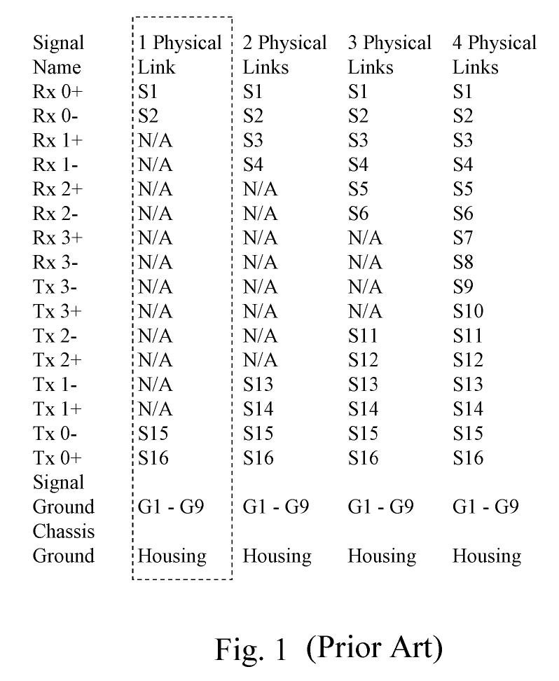

FIG. 2 is a schematic view of a system of testing SAS channels in the conventional art.

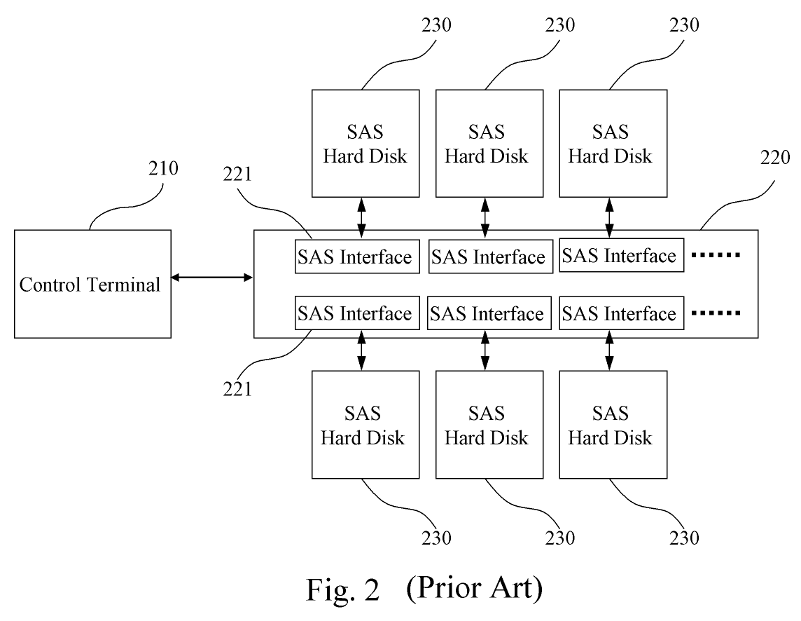

FIG. 3 is a flow chart of a detection of SAS channels in the conventional art.

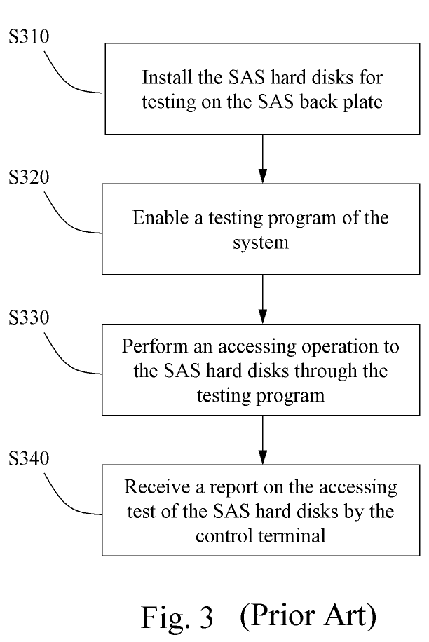

FIG. 4 is a schematic view of a system of testing bridge SAS channels according to the present invention.

FIG. 5 is a flow chart of operations of a detection device of bridge SAS channels according to the present invention.

FIG. 6 is a flow chart of operations of detecting a USB terminal unit according to the present invention.

FIG. 7 is a schematic view of the detection of the USB terminal unit according to the present invention.

### DETAILED DESCRIPTION OF THE INVENTION

The system of testing bridge SAS channels in the present invention is applicable for a plurality of pairs of SAS interfaces included in an SAS back plate. The testing system bridges a plurality of terminal units to the SAS back plate to detect whether the SAS interface selected by the SAS back plate and the transmission channel can normally operating or not. The system of testing bridge SAS channels includes a control terminal 410, a hot-plug bridge interface 420, a first adaptor 430, an SAS back plate 440, and a second adaptor 450.

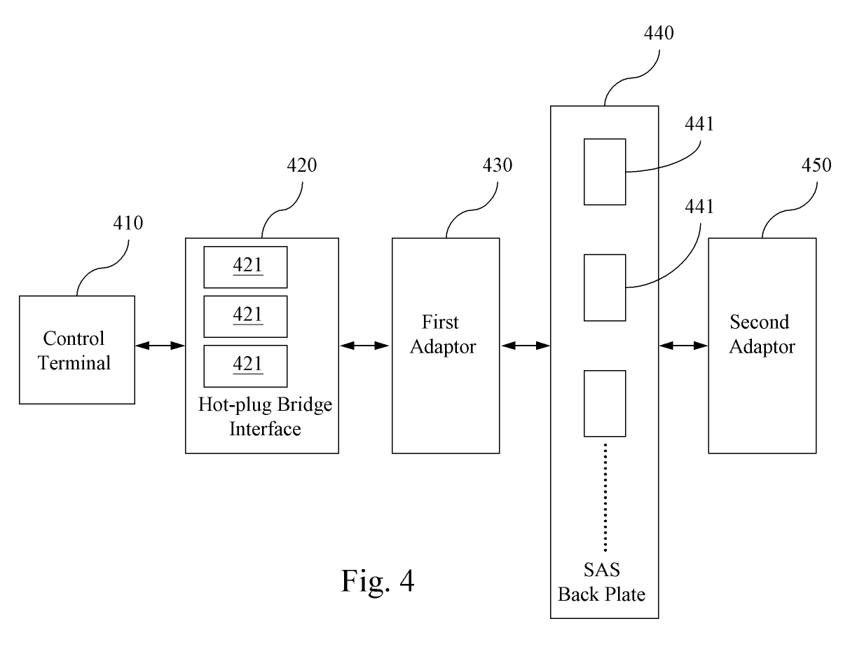

Referring to FIG. 4, it is a schematic view of a system of testing bridge SAS channels according to the present invention. The system of testing bridge SAS channels is further connected to a testing equipment. The control terminal 410 is used to send a test signal and detect a signal fed back from the terminal unit. The control terminal 410 can be, but not limited to, a personal computer, a notebook computer, or a server. The control terminal 410 selects an SAS interface 441 to be tested in the SAS back plate 440 to serve as a transmission path for sending the test signal.

The hot-plug bridge interface 420 is electrically connected to the control terminal 410. And the hot-plug bridge interface 420 receives and converts the test signal sent from the control terminal 410. The hot-plug bridge interface 420 is a USB or an IEEE 1394. The hot-plug bridge interface 420 further includes a plurality of bridge ports 421 respectively connected to the corresponding SAS interface 441. The hot-plug bridge interface can be a USB or an IEEE 1394, so the terminal unit can be a terminal unit for a USB interface or an IEEE 1394 bus interface. The control terminal 410 bridges the terminal unit for the hot-plug interface, and once the control terminal 410 performs the test or after the test is completed, the SAS back plate can be directly removed without shutting down the system.

The first adaptor 430 is electrically connected to the hot-plug bridge interface 420 and the SAS back plate 440 respectively, and converts a low voltage difference signal of the hot-plug bridge interface 420 to the SAS interface 441. The second adaptor 450 is electrically connected to the SAS back plate 440 and the terminal unit respectively, and converts a low voltage differential signal of the SAS interface 441 to the terminal unit.

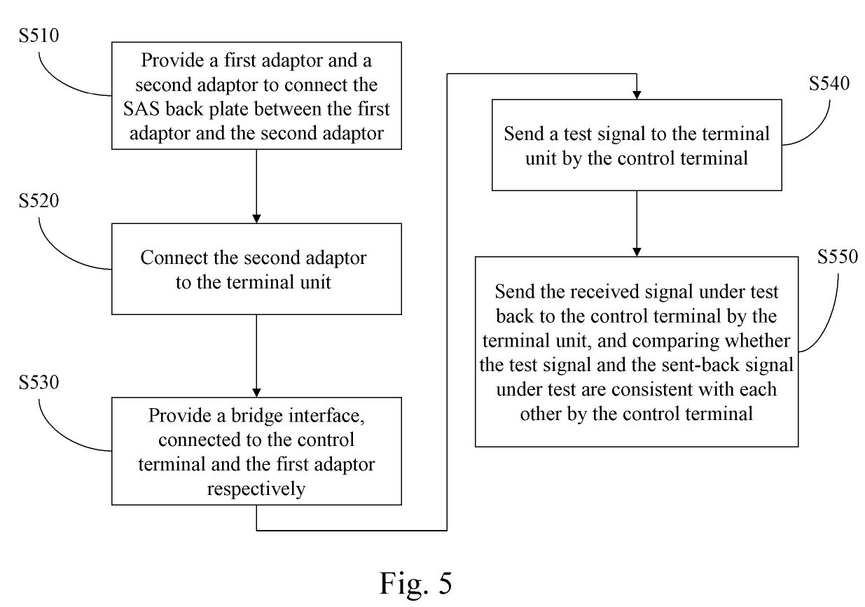

Referring to FIG. 5, it is a flow chart of operations of a detection device of bridge SAS channels according to the present invention. The testing method includes the following steps: firstly, providing a first adaptor and a second adaptor, to connect the SAS back plate between the first adaptor and the second adaptor (Step S510); next, connecting the second adaptor to the terminal unit (Step S520); then, providing a hot-plug bridge interface, connected to the control terminal and the first adaptor respectively (Step S530); then, sending the test signal to the terminal unit from the control terminal (Step S540); afterwards, sending the received signal under test back to the control terminal by the terminal unit, and comparing whether the test signal and the sent-back signal under test are consistent with each other by the control terminal (Step S550).

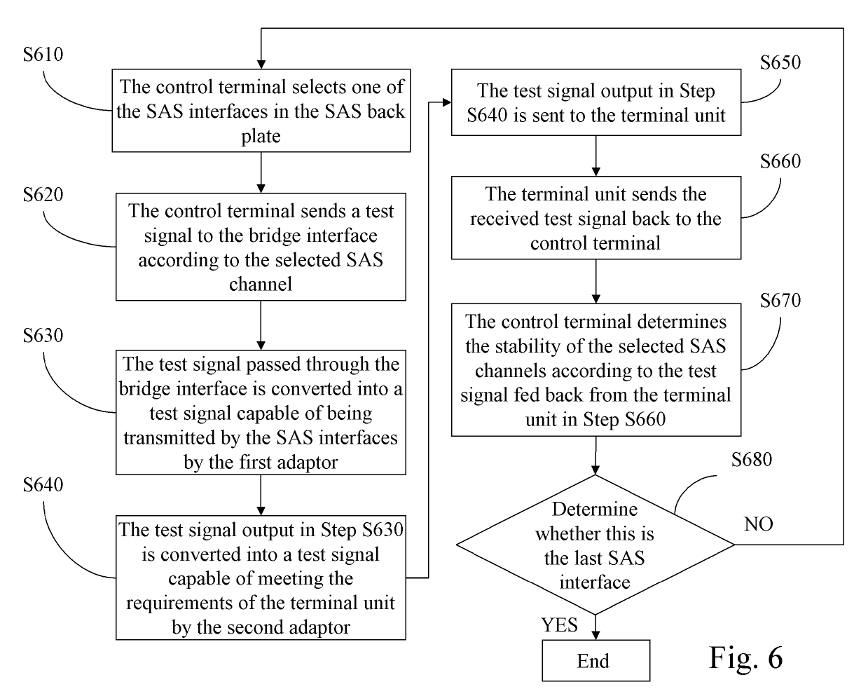

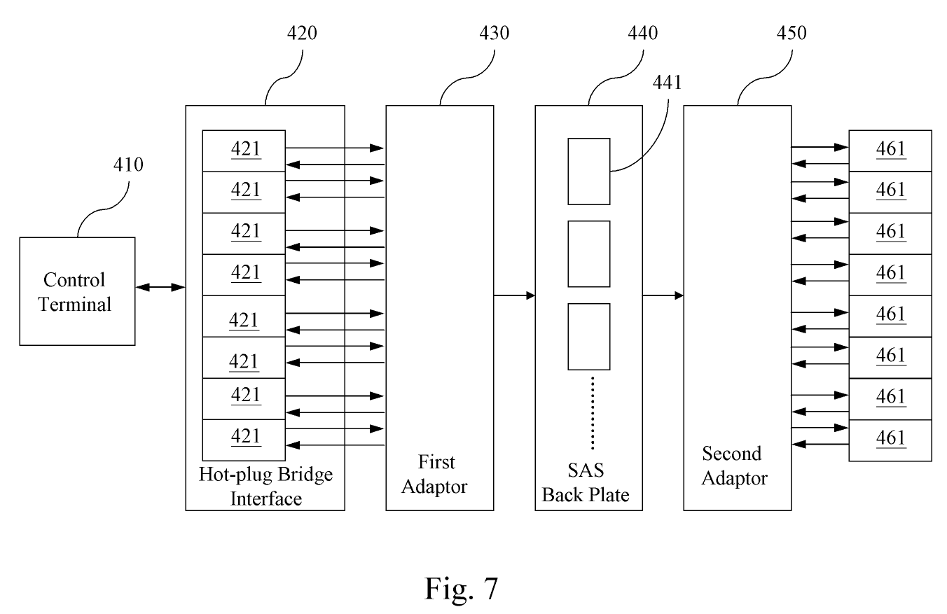

In order to clearly illustrate the using method of the testing device of the present invention, a USB device is taken as the terminal unit in this embodiment. Referring to FIGS. 6 and 7 together, they are respectively a flow chart of operations of detecting a USB terminal unit according to the present invention and a schematic view of the detection of the USB terminal unit according to the present invention.

In order to illustrate the operation flow of the present invention, a USB is taken as a connection interface of the terminal unit in this embodiment. Firstly, the control terminal selects one of the SAS interfaces in the SAS back plate (Step S610). Next, according to the selected SAS interface, the control terminal sends a test signal to the hot-plug bridge interface (Step S620). Since a low voltage difference signal is taken as the transmission manner in the SAS channels, a low voltage difference signal is also utilized in the USB interface. However, both of them are different from each other in terms of the transmission voltage and number of channels. Therefore, the present invention firstly uses the hot-plug bridge interface 420 to integrate the transmission channels of the USB with that of the SAS. The USB transmission channels merely have two transmission lines D+ and D− therein, and the SAS transmission channels have 16 transmission lines, such that it is required to provide 8 bridge ports 421 in the hot-plug bridge interface 420, so as to completely cover the SAS transmission channels.

The test signal passed through the hot-plug bridge interface is converted into a test signal capable of being transmitted by the SAS interface by the first adaptor (Step S630). Then, the transmission signal of the USB interface is converted into a transmission signal of the SAS interface through the first adaptor 430, which mainly aims at converting the transmission voltage of the USB and that of the SAS. Next, the SAS transmission signal is converted into a USB transmission signal through the second adaptor 450, and then sent to a corresponding USB terminal unit 461. As mentioned above, since the number of the SAS transmission lines is different from that of the USB transmission lines, 8 USB terminal units 461 are required to be connected to one SAS interface 441, so as to completely cover the SAS transmission channels. Although the number of the USB terminal units 461 is greater than that of the original SAS terminal units, the advantage of this process lies in that, it is capable of detecting whether each pair of the low voltage difference signal lines in the SAS transmission channels can correctly transmit data, so that the testing personnel can accurately find out an incorrect channel in the SAS interfaces 441.

Next, the test signal output in Step S630 is converted into a test signal capable of meeting the requirements of the terminal unit by the second adaptor (Step S640). Next, the test signal output in Step S640 is sent to the terminal unit (Step S650). Then, the terminal unit sends the received test signal back to the control terminal (Step S660). Then, the control terminal determines the stability of the selected SAS channel according to the test signal feed back from the terminal unit in Step S660 (Step S670). Finally, the control terminal 410 sends the test signal, and the test signal is transmitted through the hot-plug bridge interface 420, the first adaptor 430, the SAS interfaces 441, and the second adaptor 450, to reach the USB terminal unit 461. Once the USB terminal unit 461 receives the signal under test, it feeds a signal back to the control terminal, and then, the control terminal compares whether the signal under test and the sent-back signal are consistent with each other or not.

It is determined whether this is the last SAS interface (Step S680). If there is still another SAS interface that has not been tested yet, Step S610 is repeated till all the SAS channels have been tested.

In the present invention, the SAS back plate is used for bridging the terminal units. When it is tested whether the test signal passing through the SAS channels of the SAS back plate is intact or not, the SAS back plate can be replaced by a new one without shutting down the power and rebooting the system, so as to perform the SAS back plate test in the next cycle. In such a manner, the whole time spent on testing the SAS channels can be reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system of testing bridge SAS channels, applicable for a plurality of pairs of SAS interfaces included in an SAS back plate, wherein the testing system is connected to a plurality of terminal units through bridge SAS interfaces to detect a test signal accessed in the terminal units and to detect whether the SAS interfaces run normally or not according to the test signal, comprising:
a control terminal, for sending a test signal and detecting a signal under test sent back from the terminal units, wherein the control terminal selects one of the SAS interfaces as a transmission path for sending the test signal;
a hot-plug bridge interface, electrically connected to the control terminal, for receiving and converting the test signal sent from the control terminal, wherein when the control terminal is operated, the terminal units can perform a plugging operation;
a first adaptor, electrically connected to the hot-plug bridge interface and the SAS back plate respectively, for converting a low voltage difference signal of the hot-plug bridge interface to the SAS channels; and
a second adaptor, electrically connected between the SAS back plate and the terminal units respectively, for converting a low voltage differential signal of the SAS interface to the hot-plug bridge interface, and accessing the terminal units.

2. The system of testing bridge SAS channels as claimed in claim 1, wherein the hot-plug bridge interface further comprises at least one bridge port, for being connected to the first adaptor respectively, and the number of the bridge ports is determined depending upon the number of the low voltage difference signal lines in the SAS back plate.

3. The system of testing bridge SAS channels as claimed in claim 1, wherein the hot-plug bridge interface is a universal serial bus (USB) or an IEEE 1394 interface.

4. The system of testing bridge SAS channels as claimed in claim 1, wherein the terminal unit is a USB terminal unit.

5. The system of testing bridge SAS channels as claimed in claim 1, wherein the terminal unit is an IEEE 1394 terminal unit.

6. A method of testing bridge SAS channels, for bridging and accessing a plurality of terminal units, to detect whether the SAS interfaces are normal or not, comprising:
providing a first adaptor and a second adaptor, to connect an SAS back plate between the first adaptor and the second adaptor;
connecting the second adaptor to the terminal units;
providing a plurality of hot-plug bridge interfaces, respectively connected to a control terminal and the first adaptor;
sending a test signal to the terminal units from the control terminal; and
sending a received signal under test back to the control terminal by the terminal units, and comparing whether the test signal and the sent-back signal under test are consistent with each other by the control terminal.

7. The method of testing bridge SAS channels as claimed in claim 6, wherein the hot-plug bridge interfaces is determined depending upon the number of a plurality of low voltage difference signals for the SAS channel.

8. The method of testing bridge SAS channels as claimed in claim 6, wherein the hot-plug bridge interfaces is a USB interface or an IEEE 1394 interface.

9. The method of testing bridge SAS channels as claimed in claim 6, wherein the terminal unit is a USB terminal unit.

10. The method of testing bridge SAS channels as claimed in claim 6, wherein the terminal unit is an IEEE 1394 terminal unit.
